(19) United States
(12) Patent Application Publication
(10) Pub. No.: US 2011/0011998 A1
(43) Pub. Date: Jan. 20, 2011

(54) SUBSTRATE HOLDING/FIXING STRUCTURE

(76) Inventor: Masakazu SHOJI, Tokyo (JP)

Correspondence Address: BIRCH STEWART KOLASCH & BIRCH, PO BOX 747, FALLS CHURCH, VA, 22040-0747, US

(21) Appl. No.: 12/921,810

(22) PCT Filed: May 8, 2009
(86) PCT No.: PCT/JP2009/002021

§ 371 Date: Sep. 10, 2010

(30) Foreign Application Priority Data
Jun. 5, 2008 (JP) 2008-148359

(51) Int. Cl. F16M 13/02

(52) U.S. Cl. 248/225.11

(57) ABSTRACT

An elastic strip member 4 is formed in a chassis 3, and the above-mentioned strip member 4 is brought into contact with a substrate 1 and the above-mentioned substrate 1 is screwed to the above-mentioned chassis 4.

### FIELD OF THE INVENTION

The present invention relates to a structure of holding and fixing a substrate to a chassis.

### BACKGROUND OF THE INVENTION

In electronic equipment and so on, a body part is constructed by holding and fixing a substrate on which electronic parts and so on are mounted to a chassis which is a metal plate. In a conventional typical structure of fixing a substrate to a chassis, the substrate 101 is laid over the chassis 102 and they are screwed together with a plurality of screw threads 103, as shown in FIGS. 9A and 9B. As shown in FIG. 10, protruding screw stoppers 102a are formed on the chassis 102, and the substrate 101 is laid over the chassis and screws 103 are passed through tapped holes 101a formed in the substrate 101 from the surface side of the substrate 101 and are screwed into the protruding screw stoppers 102a of the chassis 102 respectively.

As a fixing method not using screws, there has been considered a structure of forming a slit and a strip member having a spring feature in a side surface of a chassis, and, when a protruding piece of a substrate is inserted into the slit, holding the protruding piece by using the spring feature of the strip member (patent reference 1). Furthermore, a structure of forming strip members in four surfaces of a box-like chassis with their positions being shifted from one another with respect to a vertical direction, and sandwiching a substrate in the vertical direction by using these strip members to hold the substrate has been proposed (patent reference 2). In addition, as shown in FIGS. 11A, 11B and 11C, a structure of holding and fixing a tongue piece part 112 constructed by bending a part of a chassis 111 by bringing the tongue piece part into contact with a substrate 113 has been proposed (patent reference 3). FIG. 11A is a perspective view of a state in which the substrate has not been mounted to the chassis yet, FIG. 11B is a plane view of the strip member in the chassis, and FIG. 11C is a cross-sectional view taken along the line c-c of FIG. 11B.

### RELATED ART DOCUMENTS

### Patent references

[Patent reference 1] JP,7-32991,U
[Patent reference 2] JP,2006-186157,A
[Patent reference 3] JP,3644593,B

### SUMMARY OF THE INVENTION

A problem with the typical structure as shown in FIGS. 9A, 9B, and 10 is, however, that because the substrate 101 is held and fixed to the chassis 102 only with the screws 103, the substrate cannot be sufficiently fixed to the chassis with the screws in a case in which electronic parts and so on are mounted on the substrate surface and the screws cannot be used, or the number of layers laminated in the substrate increases. Furthermore, in the structure described in patent reference 1, screws are needed in order to suppress bending of the central portion of the substrate, and therefore the use of screws presents the same problem. The structure described in patent reference 2 also needs screws in order to suppress bending of the central portion of the substrate, and therefore the use of screws presents the same problem. In the structure described in patent reference 3, the tip of the tongue piece part 112 is brought into contact with the substrate 113 in such a way that the substrate is held, though the substrate 113 has be forced against the tongue piece part 112 in order to prevent the occurrence of chattering or the like at this contact portion. As a result, a stress is applied to the substrate 113 permanently, and the same problem as shown in FIGS. 9A, 9B, and 10 arises. In addition, in a case in which such a structure is applied to equipment, such as a vehicle-mounted audio car navigation system, being used under environments in which vibrations are added to the equipment, because the vibrations are added to the equipment in a state in which a stress is applied to the substrate, the life of the substrate is forecast to be adversely affected.

It is therefore an object of the present invention to provide a holding/fixing structure of holding and fixing a substrate to a chassis, the structure being able to prevent the substrate from being bent, and also prevent chattering from occurring.

In accordance with the present invention, there is provided a substrate holding/fixing structure for holding and fixing a substrate to a chassis, wherein an elastic strip member is formed in the above-mentioned chassis, and the above-mentioned strip member is brought into contact with the above-mentioned substrate and the above-mentioned substrate is screwed to the above-mentioned chassis.

In the substrate holding/fixing structure in accordance with the present invention, because the strip member having elasticity holds the substrate flexibly, the substrate can be prevented from being bent and chattering can be prevented from occurring even if vibrations are applied to the structure. Furthermore, the number of screws for use in the structure can be reduced, and this results in increase in the area where electronic parts can be arranged and an improvement in the degree of freedom of the design.

### BRIEF DESCRIPTION OF THE FIGURES

FIG. 1A is a perspective view showing a substrate holding/fixing structure yet to be assembled in accordance with Embodiment 1;

FIG. 1B is a perspective view showing the substrate holding/fixing structure assembled in accordance with Embodiment 1;

FIG. 2A is a perspective view of a strip member in the substrate holding/fixing structure in accordance with Embodiment 1;

FIG. 2A is a plane view of the strip member in the substrate holding/fixing structure in accordance with Embodiment 1;

FIG. 2C is a cross-sectional view of FIG. 2B as viewed from the direction of arrows a;

FIG. 2D is a cross-sectional view of a chassis including the strip member, and a substrate in the substrate holding/fixing structure in accordance with Embodiment 1;

FIG. 3 is a perspective view of the strip member in the substrate holding/fixing structure in accordance with Embodiment 1;

FIG. 4A is a perspective view of a strip member in a substrate holding/fixing structure in accordance with Embodiment 2;

FIG. 4B is a perspective view of another example of the strip member in the substrate holding/fixing structure in accordance with Embodiment 2;

FIG. 5 is a perspective view of another example of the strip member in the substrate holding/fixing structure in accordance with Embodiment 2;

FIG. 6A is a perspective view of a strip member in a substrate holding/fixing structure in accordance with Embodiment 3;

FIG. 6B is a plane view of the strip member in the substrate holding/fixing structure in accordance with Embodiment 3;

FIG. 6C is a cross-sectional view of a chassis including the strip member in the substrate holding/fixing structure in accordance with Embodiment 3;

FIG. 6D is a cross-sectional view of the chassis including the strip member, and a substrate in the substrate holding/fixing structure in accordance with Embodiment 3;

FIG. 7 is a perspective outline view of a substrate holding/fixing structure in accordance with Embodiment 4;

FIG. 8A is a perspective view showing a state in which a substrate holding/fixing structure in accordance with Embodiment 5 is assembled;

FIG. 8B is a cross-sectional view of FIG. 8A as viewed from the direction of arrows b;

FIG. 9A is a perspective view of an example of a conventional substrate holding structure;

FIG. 9B is a perspective view of another example of the conventional substrate holding structure;

FIG. 10 is a cross-sectional view of a screw stopper shown in FIGS. 9A and 9B;

FIG. 11A is a perspective view showing a further example yet to be assembled of the conventional substrate holding structure;

FIG. 11B is a plane view of a strip member shown in FIG. 11A; and

FIG. 11C is a cross-sectional view of FIG. 11B, as viewed from the direction of arrows c, showing a portion at which the strip member is in contact with a substrate.

### EMBODIMENTS OF THE INVENTION

Hereafter, in order to explain this invention in greater detail, the preferred embodiments of the present invention will be described with reference to the accompanying drawings.

### Embodiment 1

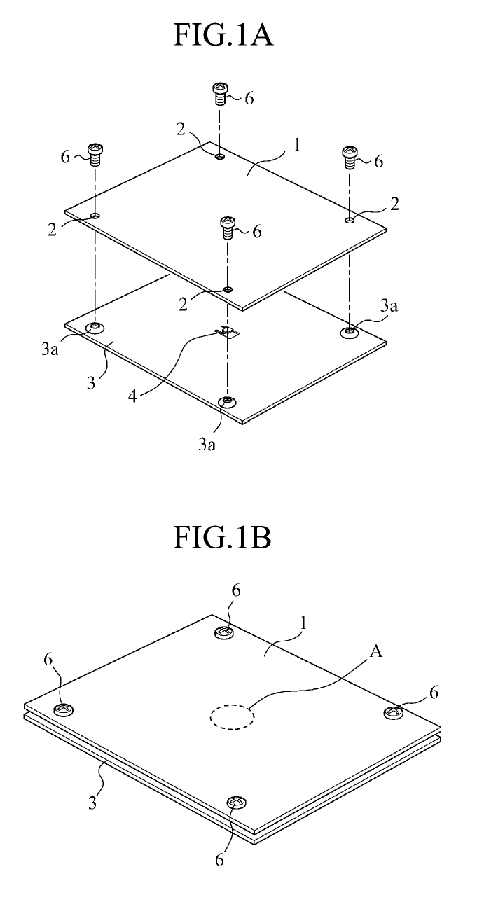

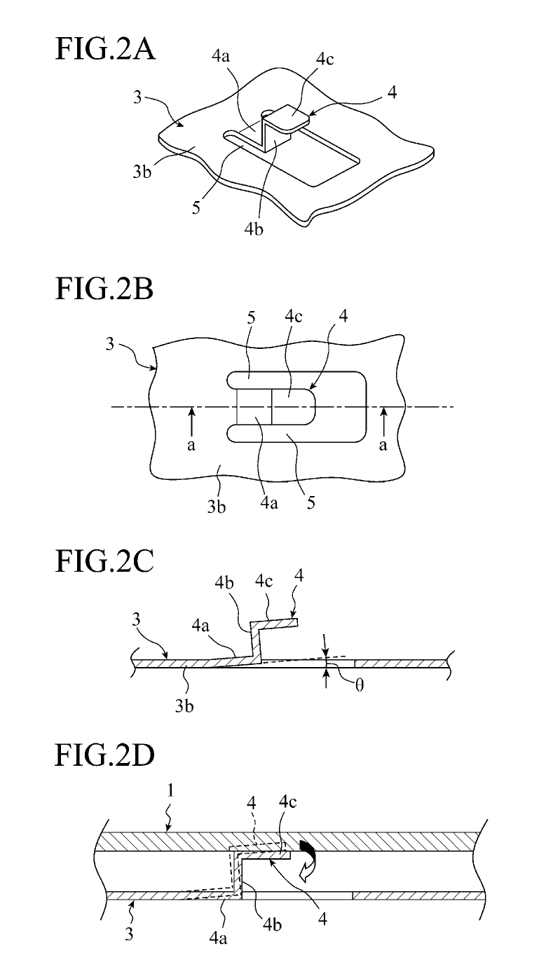

Hereafter, a substrate holding/fixing structure in accordance with Embodiment 1 of the present invention will be explained with reference to drawings. FIG. 1A is a perspective view showing the substrate holding/fixing structure yet to be assembled in accordance with Embodiment 1, and FIG. 1B is a perspective view showing the substrate holding/fixing structure assembled. FIGS. 2A, 2B, 2C, and 2D are a perspective view, a plane view, and a cross-sectional view showing a strip member formed in a chassis, and a cross-sectional view showing the strip member formed in the chassis together with a substrate respectively.

Although not illustrated in the figures, electronic parts and wiring are mounted on one or both of side surfaces of the substrate 1. Screw holes 2 through which screws are passed are formed in the four corners of the substrate 1 respectively. The chassis 3 is made from an elastic material, such as a metal plate. Screw stoppers 3a respectively corresponding to the screw holes 2 of the substrate 1 are formed in the four corners of the chassis 3 in such a way as to protrude from the chassis (refer to FIG. 10). Each of the screw stoppers 3a is tapped in such a way that a screw is screwed into each of the screw stoppers. The height of the protruding screw stoppers 3a defines the distance between the chassis 3 and the substrate 1.

The strip member 4 is formed in a center portion of the chassis 3. As shown in FIGS. 2A to 2C, a slit 5 is cut in the chassis 3 which is a metal plate to form a rectangle-shaped strip and this strip is then bent in such a way that the strip has a Z-shaped cross section, so that the strip member 4 is formed. The strip member 4 consists of a root portion 4a connected to a body part 3b of the chassis 3 (the body part consists of portions except the strip member 4 and the screw stoppers 3a), a rising portion 4b which is bent from the root portion 4a in a direction approximately perpendicular to the root portion 4a, and a contact portion 4c which is bent from the rising portion 4b in a direction approximately perpendicular to the rising portion 4b and which is extending in the same direction as that in which the body part 3b of the chassis 3 is extending. A slight angle θ with respect to the body part 3b of the chassis 3 is added to the root portion 4a, as shown in FIG. 2C, and this slight angle results in effective addition of spring elasticity to the strip member 4.

When the substrate 1 is placed on the chassis 3 and the four corners of the substrate 1 and those of the chassis 3 are secured together with the screws 6, the contact portion 4c of the strip member 4 is brought into contact with the rear face of the substrate 1, as shown in FIG. 2D. In FIG. 1B, A shows a position at which the strip member 4 is formed. Because the strip member 4 is pressed down by the substrate 1, the strip member 4 becomes deformed because of the spring elasticity thereof. More specifically, the contact portion 4c of the strip member 4 is brought into contact with the rear face of the substrate 1 while having the spring elasticity. In this Embodiment 1, when the contact portion 4c is brought into contact with the rear face of the substrate 1, the angle of the root portion 4a with respect to the body part 3b of the chassis 3 becomes zero. By constructing the strip member in this way, no projection appears on the surface of the chassis 3, and the occurrence of a trouble, such as a hit of an electric part onto the chassis in the case of handling this assembly, can be prevented.

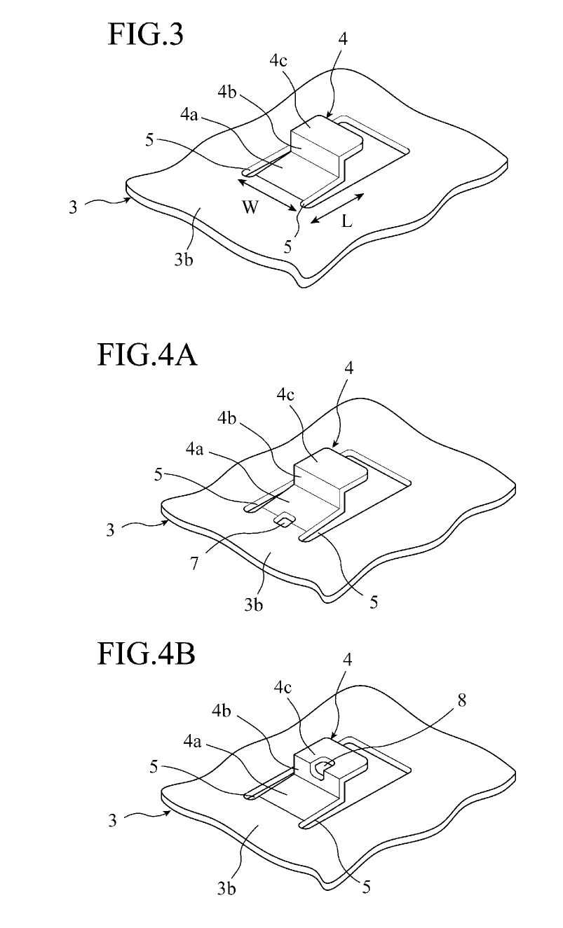

By adjusting the spring elasticity of the strip member 4 to be appropriate, the substrate 1 can be held without imposing a stress on the substrate 1. The spring elasticity of the strip member 4 can be adjusted according to not only the angle θ, but also the shape and structure of the strip member 4. As shown in FIG. 3, by changing the length L of a portion of the slit 5 extending between the root portion 4a of the strip member 4 and the body part 3b of the chassis 3 and the width W of the strip member 4, the spring elasticity which the strip member 4 exhibits can be changed.

According to the substrate holding/fixing structure in accordance with this Embodiment 1, the strip member 4 having elasticity holds the substrate 1 flexibly. Therefore, the substrate 1 can be prevented from being bent and a constant stress can be prevented from being applied to the substrate 1, and, even in a case in which the substrate holding/fixing structure is applied to equipment, such as a vehicle-mounted audio car navigation system, being used under environments in which vibrations are added to the equipment, chattering does not occur in the structure. Furthermore, the number of screws for use in the structure can be reduced and this results in reduction in the material cost. Because there are no screw heads on the surface of the substrate 1 except those in the four corners, the area on which electronic parts can be arranged increases, and the degree of freedom of the design becomes high. In the substrate holding/fixing structure in accordance with this Embodiment 1, a desired spring force can be generated by the simple structure of providing the root portion 4a of the strip member 4 with the angle θ. Because the strip member 4 having a Z-shaped cross section can be formed by using typical sheet-metal working, any increase in the number of working hours and so on can be prevented.

### Embodiment 2

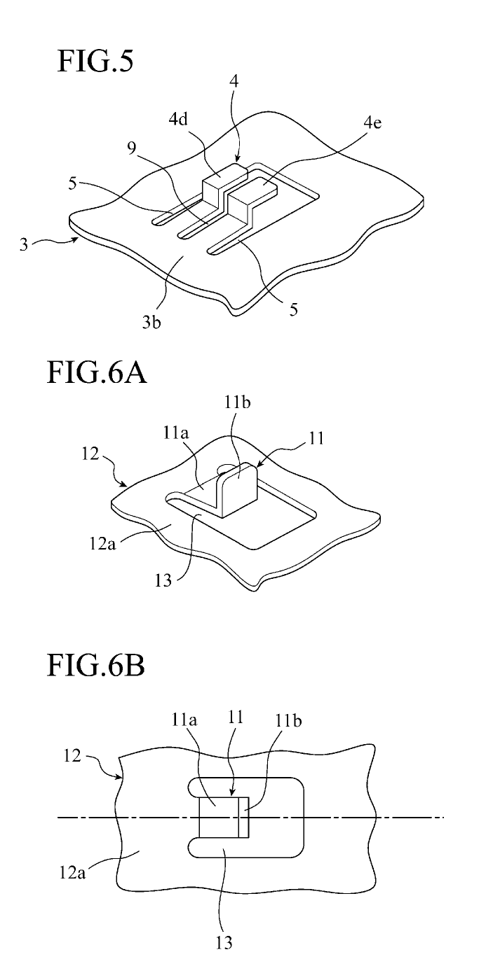

The strip member 4 is not limited to the above-mentioned one which is formed by cutting the slit 5 in the chassis 3 and then bending the strip defined by the slit in such a way that the strip has a Z-shaped cross section. There can be provided a strip member which is obtained by further machining the above-mentioned strip member. Examples of such a strip member are shown, as Embodiment 2, in FIGS. 4A, 4B, and 5. FIGS. 4A, 4B, and 5 are perspective views showing the examples of the strip member in a substrate holding/fixing structure in accordance with Embodiment 2.

In the example shown in FIG. 4A, a hole 7 is formed in a connecting portion of the root portion 4a of the strip member 4 connecting with the body part 3b of the chassis. The spring elasticity of the root portion 4a can be adjusted by adjusting the size and shape of each hole 7, or the number of holes 7. In the example shown in FIG. 4B, a hole 8 is formed in a connecting portion of the strip member 4 connecting between the rising portion 4b of the strip member 4 and the contact portion 4c of the strip member 4. Also in this example, the spring elasticity of the root portion 4a can be adjusted by adjusting the size and shape of each hole 8, or the number of holes 8.

In addition, the spring elasticity of the strip member 4 can be adjusted by adding a slit 9 between two parts of the slit 5 to divide the strip member 4 into a strip member part 4d and a strip member part 4e, as shown in FIG. 5. The spring elasticities of the strip members 4d and 4e can be adjusted by changing the width of each slit 9, the number of slits 9, or the like. The spring elasticity of the strip member 4 can also be adjusted by combining some of the examples shown in FIGS. 4A, 4B, and 5.

In the substrate holding/fixing structure in accordance with this Embodiment, the hole 7 or 8, or the slit 9 is formed in the strip member 4. The strip member can be formed to have desired spring elasticity, and the substrate 1 can be held against the chassis 3 without applying any stress to the substrate 1 and while preventing chattering and so on from occurring in the structure even in a case in which the structure is used under environments in which vibrations are added to the structure.

### Embodiment 3

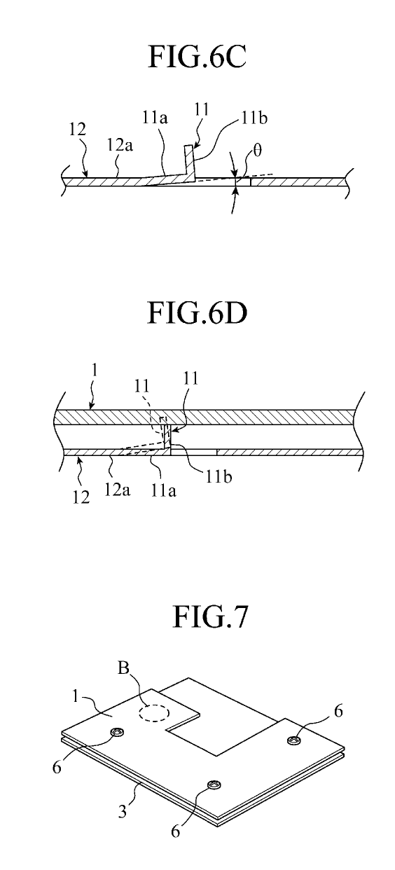

FIGS. 6A, 6B, 6C, and 6D are a perspective outline view, a plane view, a cross sectional view of a strip member in accordance with Embodiment 3, and a cross sectional view of the strip member being in contact with a substrate respectively. The configuration of components other than the strip member is the same as, for example, that shown in FIGS. 1A and 1B.

The strip member 11 is formed by cutting a slit 13 in a chassis 12 which is a metal plate to form a rectangle-shaped strip, and then bending this strip only once in such a way that the strip has an L-shaped cross section. The strip member 11 consists of a root portion 11a connected to a body part 12a of the chassis 12 (the body part consists of portions except the strip member 11 and screw stoppers 3a (see FIG. 1A), and a rising contact portion 11b which is bent from the root portion 11a in a direction approximately perpendicular to the root portion. A slight angle θ with respect to the body part 12a of the chassis 12 is added to the root portion 11a, as shown in FIG. 6C, and this slight angle results in effective addition of spring elasticity to the strip member 11. Because an upper end of the contact portion 11b is brought into contact with the substrate 1, the upper end is rounded in such a way that the upper end does not make a scratch or the like on the substrate 1.

When the substrate 1 is placed on the chassis 12 and the four corners of the substrate 1 and those of the chassis 12 are secured together with screws 6, the contact portion 11b of the strip member 11 is brought into contact with the rear face of the substrate 1, as shown in FIG. 6D. Because the strip member 11 is pressed down by the substrate 1, the strip member 11 becomes deformed because of the spring elasticity of the strip member. More specifically, the contact portion 11b of the strip member 11 is brought into contact with the rear face of the substrate 1 while having the spring elasticity. In this Embodiment 3, when the contact portion 11b is brought into contact with the rear face of the substrate 1, the angle of the root portion 11a with respect to the body part 12a of the chassis 12 becomes zero. By constructing the strip member in this way, no projection appears on the surface of the chassis 12, and the occurrence of a trouble, such as a hit of an electric part onto the chassis in the case of handling this assembly, can be prevented.

According to the substrate holding/fixing structure in accordance with this Embodiment 3, the strip member 11 having elasticity holds the substrate 1 flexibly. Therefore, the substrate 1 can be prevented from being bent and a constant stress can be prevented from being applied to the substrate 1, and, even in a case in which the substrate holding/fixing structure is applied to equipment, such as a vehicle-mounted audio car navigation system, being used under environments in which vibrations are added to the equipment, chattering does not occur in the structure. Furthermore, the number of screws for use in the structure can be reduced and this results in reduction in the material cost. Because the number of screws can be reduced, the area on which electronic parts can be arranged increases, and the degree of freedom of the design becomes high. In the substrate holding/fixing structure in accordance with this Embodiment 3, a desired spring force can be generated by the simple structure of providing the root portion 11a of the strip member 11 with the angle θ. In addition, in the substrate holding/fixing structure in accordance with this Embodiment 3, because the strip member 11 has an L-shaped cross section, it is very easy to manufacture the structure. Because the strip member 11 having an L-shaped cross section can be formed by using typical sheet-metal working, any increase in the number of working hours and so on can be prevented.

### Embodiment 4

FIG. 7 shows a perspective outline view of a substrate holding/fixing structure in accordance with Embodiment 4. In this Embodiment 4, a substrate 1 differs from that in accordance with Embodiment 1 which is shaped simply like a quadrangle in that the substrate 1 has an asymmetrical U-shaped plane. Three corner parts of the substrate 1 are secured to a chassis 3 with screws 6. A remaining corner part B of the substrate is held by a strip member formed in the chassis 3. For example, as the strip member, the strip member shown in either one of FIGS. 2A to 2D, 4A, 4B, 5, and 6A to 6D is used.

Even if the substrate 1 has a different shape, the holding of one or more portions of the substrate 1 to the chassis by using one or more strip members as shown in this Embodiment 4 can hold the substrate 1 to the chassis without applying any stress to the substrate 1 and while preventing chattering and so on from occurring in the structure even when vibrations are added to the structure, like in the case of the other embodiments. In addition, because the number of points where the substrate is secured to the chassis with the screws can be reduced irrespective of the shape of the substrate, the available area of the substrate 1 can be increased.

### Embodiment 5

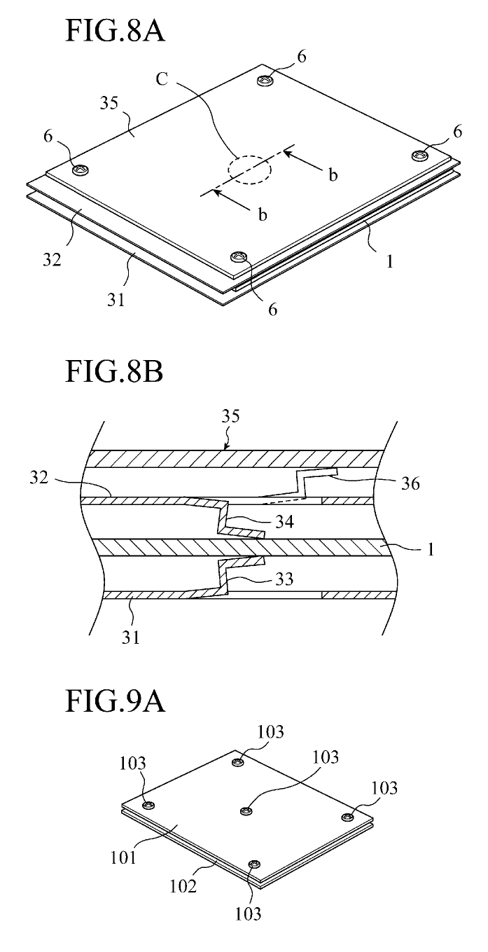

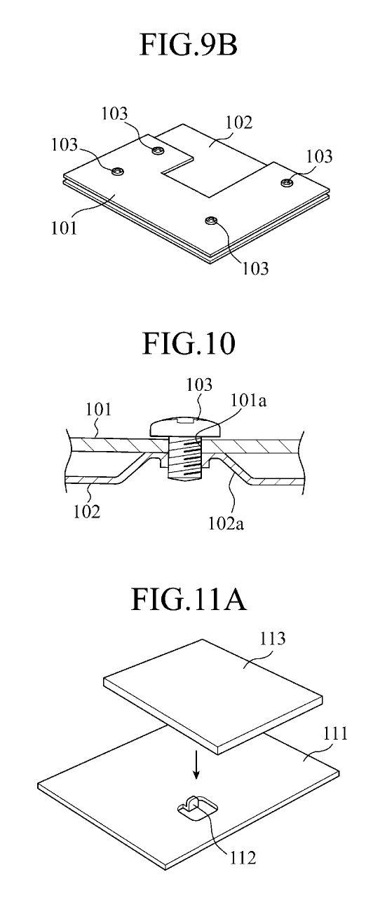

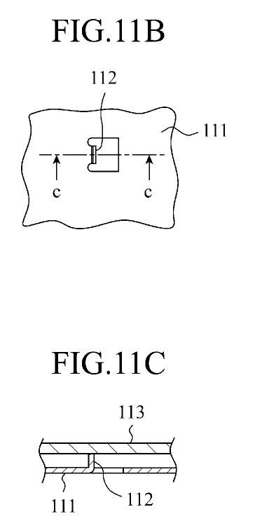

FIG. 8A is a perspective view showing a state in which a substrate holding/fixing structure in accordance with Embodiment 5 is assembled, and FIG. 8B is a cross-sectional view taken along the line b-b of FIG. 8A. In FIG. 8A, C shows a portion in which a strip member is formed. In the substrate holding/fixing structure in accordance with this Embodiment 5, a substrate 1 is sandwiched between a first chassis 31 and a second chassis 32. Furthermore, the second chassis 32 is structured in such a way as to have strip members in both side surfaces thereof.

A strip member 33 is formed in a side surface of the first chassis 31 which faces the substrate 1. This strip member 33 has such a structure as shown in FIGS. 2A and 2B. The strip member 34 is formed in a part of the second chassis 32 facing the substrate 1 and corresponding to the above-mentioned strip member 33. Also this strip member 34 has such a structure as shown in either one of FIGS. 2A to 2D, 4A, 4B, 5, and 6A to 6D. In this Embodiment 5, a substrate 35 is also arranged over an outside surface of the second chassis 32. In the second chassis 32, in addition to the strip member formed on the side of the substrate 1, the strip member 36 is also formed on the side of the substrate 35. The strip member 36 is formed in a part of the second chassis which is different from the portion where the strip member 34 is formed. The strip member has such a structure as shown in either one of FIGS. 2A to 2D, 4A, 4B, 5, and 6A to 6D.

Although not illustrated in the figures, protruding screw stoppers (refer to FIG. 10) which are tapped are formed in the four corners of the first chassis 31 respectively, and screw holes via which screws are passed are formed in corresponding portions of each of the substrate 1, the second chassis 32, and the substrate 35 respectively. The screw holes via which the screws are passed can be formed in each of the front and rear side surfaces of the second chassis 32 in such a way as to protrude from each of the front and rear side surfaces to define the distance between the second chassis 32 and the substrate 1, and the distance between the second chassis 32 and the substrate 35. In a case in which the screw holes are formed in such a way as not to protrude from the front and rear side surfaces of the second chassis, spacers for defining the distance between the second chassis 32 and the substrate 1, and the distance between the second chassis 32 and the substrate 35 are disposed.

When assembling the substrate holding/fixing structure in accordance with this Embodiment 5, the first chassis 31, the substrate 1, the second chassis 32, and the substrate 35b are put on top of one another, the screws 6 are passed through the four corners of those elements, and the screws 6 are screwed into the screw stoppers of the first chassis 31, so that the substrate 35, the second chassis 32, the substrate 1, and the first chassis 31 are coupled into a single structural unit. The substrate 1 is sandwiched flexibly and held between the strip member 33 of the first chassis 31 and the strip member 34 of the second chassis 32. Furthermore, because the substrate 35 is brought into contact with the strip member 36 of the second chassis 32, a center portion of the substrate 35 is flexibly held by the strip member.

In the substrate holding/fixing structure in accordance with Embodiment 5, the two substrates 1 and 35 can be held to the chassis without applying any stress to the substrates and while preventing chattering and so on from occurring in the structure even when vibrations are added to the structure. Furthermore, because the substrate 1 is held in the upward and downward directions perpendicular to the substrate by the strip members 33 and 34 of the first chassis 31 and the second chassis 32 with the spring elasticities of the strip members, the substrate 1 can be held with stability. Because there is no point where the substrate 35 is secured with a screw in the center portion of the substrate 35, the available area can be increased.

### INDUSTRIAL APPLICABILITY

As mentioned above, because the substrate holding/fixing structure in accordance with the present invention has a structure of holding and fixing a substrate to a chassis, has an elastic strip member which is formed in the above-mentioned chassis, and makes the above-mentioned strip member come into contact with the above-mentioned substrate and screws the above-mentioned substrate to the above-mentioned chassis in order to prevent the substrate from being bent and also prevent chattering from occurring, the substrate holding/fixing structure in accordance with the present invention is suitable for use as a structure of holding and fixing a substrate on which electronic parts and so on are mounted in electronic equipment or the like.

1-5. (canceled)

6. A substrate holding/fixing structure for holding and fixing a substrate to a chassis, wherein
said substrate holding/fixing structure includes an elastic strip member which is formed by cutting a slit in said chassis and then bending a portion defined by the slit, elasticity of said strip member being adjusted by adjusting at least one of a length and a width of said strip member, or forming at least one of a slit and a hole in said strip member instead of or in addition to the adjustment of at least one of the length and the width of said strip member, and said strip member is brought into contact with said substrate and said substrate is screwed to said chassis.

7. The substrate holding/fixing structure according to claim 6, wherein said strip member is formed in each of both side surfaces of said chassis, and substrates are disposed on the both side surfaces of said chassis in such a way as to be brought into contact with said strip members.

8. A substrate holding/fixing structure for holding and fixing a substrate to a chassis, wherein
chassis are arranged on both side surfaces of said substrate respectively, said substrate holding/fixing structure includes elastic strip members each of which is formed by cutting a slit in a corresponding one of said chassis and then bending a portion defined by the slit, elasticity of each of said strip members being adjusted by adjusting at least one of a length and a width of said each strip member, or forming at least one of a slit and a hole in said each strip member instead of or in addition to the adjustment of at least one of the length and the width of said each strip member, and said strip members formed in said chassis are brought into contact with said substrate and said substrate and said chassis are coupled to each other.
